(19) United States
(12) Patent Application Publication
(10) Pub. No.: US 2012/0004030 A1
(43) Pub. Date: Jan. 5, 2012

(54) VIDEO TERMINAL HAVING A CURVED, UNIFIED DISPLAY

(76) Inventors: Bryan Kelly, Alamo, CA (US); Martin Lyons, Las Vegas, NV (US)

(21) Appl. No.: 12/827,527

(22) Filed: Jun. 30, 2010

(51) Int. Cl. A63F 13/00

(52) U.S. Cl. 463/31

(57) ABSTRACT

A video terminal such as a kiosk or gaming device is set forth which has a continuous curved display configured to provide one or more displays as well as a touch or gesture based player/user interface. The display by be a flexible OLED or LED display. Also disclosed in an embodiment is a mechanism to increase the size of the display for certain applications.

### COPYRIGHT NOTICE

A portion of the disclosure of this patent document contains material that is subject to copyright protection. The copyright owner has no objection to the facsimile reproduction by anyone of the patent document or the patent disclosure, as it appears in the Patent and Trademark Office patent files or records, but otherwise reserves all copyright rights whatsoever.

### FIELD OF THE INVENTION

The present invention relates to video terminals and kiosks and more particularly to gaming devices have a single display which encompasses several content displays.

### BACKGROUND

Video terminals and kiosks are well known for providing goods/services to users. Examples include banking automatic teller machines (ATMs), airline ticketing and automated check-in kiosks, promotions kiosks located in stores and malls and the like. Typically these kiosks have a video display such as a CRT or LCD display and a button panel or touch screen to permit the user to interface with the operative host for the terminal such as a financial institution or airline company.

In the gaming field often a casino will operate a player loyalty program through which they provide to enrolling players a machine readable card or other device which the player presents to obtain promotions. These promotions may be things such as gifts, meals or cash back to the player based upon the player's wagering activities tracked via presentment of the player card. In conjunction with the program the casino typically has several player rewards kiosks disbursed throughout the casino. A player using their card can interface with the kiosk to determine the sum of their player points (points earned by the player based upon their wagering or other economic activity with the casino) as well as receive promotions and be appraised of upcoming events. Like other video terminals these kiosks have a video display such as a CRT or LCD display and a button panel or touch screen to permit the user to interface with the operative host for the terminal, in this case the casino slot management system.

In addition to the aforementioned kiosks, in the gaming field there are gaming devices. Gaming devices have been in use for more than a century. FIG. 1A shows a common gaming machine arrangement supporting a single video display. FIG. 1B shows another version of a typical gaming machine also having a single video display. With advances in graphics processing capabilities of modern slot machines many include multiple video displays as shown in FIG. 1C. These multiple video displays include a main game display, a secondary display and a player interface display to enable communication between a casino network connecting the gaming machines and the player.

To provide for player input gaming machines include electro-mechanical buttons and/or touch screen buttons defined usually at the main game display. Through the use of these buttons the player can make wagers, enable pay lines, cash-out accumulated credits, prompt a play of the game or make inter-game selections such as selecting cards in a Poker hand to discard.

It has also been known to provide a large format display (either CRT or using flat screen technology such as an LCD arranged in a portrait mode) and providing the functions of the main game display and secondary display. For example it is been known to provide a flat panel LCD display turned into a portrait configuration to functionally define the main and secondary video displays such as games such as “CASH SPIN™” and “GOLDEN WHEELS™” sold by Bally Gaming Inc. of Las Vegas, Nev. on its ALPHA™ gaming machine platform.

A drawback related to terminals and kiosks is that often the display is relatively small and hence inconvenient for providing different information or audio visual content such as advertising, video or the like. Further the displays for these devices are most typically arranged substantially vertically. Providing a touch screen or buttons also arranged vertically may result in erroneous entries or fatigue with prolonged use since the hands and shoulders must be used to manipulate the buttons. Where the buttons are arranged horizontally like a typical keyboard, the buttons must be separately wired and mounted. Further the user is required to continually reference between the display and the button keypad to make sure the desired inputs are made.

With reference to gaming machines specifically, where multiple displays are provided each display must be separately configured, wired and controlled. Further there are limitations as to what features can be presented. It is difficult to render a unified image across two or more displays which are separated or divided by a physical barrier between multiple displays. Using a single, large LCD display presents issues regarding placement and tilting of the display so as not to overwhelm the player, provide a unified view and where required position a touch screen or gesture based player interface. The flat display suggests a separate, horizontally arranged, button deck to avoid player fatigue. Still a further drawback is that in addition to the multiple displays the gaming device controller must accommodate, control and interface with the buttons. Use of a single display arranged in a portrait mode has the drawbacks of cost and positioning of the large display to be conveniently viewed by a user. The large display is flat and must be arranged to present touch screen buttons for use by the player at the lower extremity while at the same time positioning the top of the display at a location to be viewed by the player and not overwhelm the player. Thus the arrangement results in a compromise. Further the content for a large video display may require a player to constantly re-focus between the content at the top of the display which is further away versus the content which is nearer at the middle and bottom of the display. It is suggested that this arrangement may lead to fatigue of the player.

It would be advantageous to provide a single, curved display which includes a touch screen button panel positioned proximate the user/player and at least a main display whereby the curvature permits the button panel to be arranged approximately horizontal while the main display is positioned to face the user/player in a manner so as not to overwhelm or “crowd” the player but to be accessible. It would be advantageous to provide a unified display which would be more intriguing for a user. It would be advantageous to provide a display where display elements could be removed or added such as removing the display of the virtual button deck or the appearance of separate display fields to accommodate new and exciting game features and displays. It would further be more advantageous to provide a unified display so that the display field can be more integrated without the interference of barriers which exist between separate video displays. It would further be advantageous to provide a single display device which provides the multiple displays for several adjacent gaming devices. It would also be advantageous to provide a display which is relatively cheaper than a large format LCD display positioned in a portrait mode. Still further it would be advantageous to provide a gaming device having and extendable continuous display which can be expanded or contracted to accommodate game features and functions. It would also be advantageous that the curved display could be configured by a user (either manually, or automatically based upon some stored preference) to adjust the size of certain display elements.

### SUMMARY OF THE INVENTION

There is, therefore, provided according to one aspect of the present invention a cabinet is provided having a base and a video support. A curved video display is secured to said support. A controller is configured to display at said display a plurality of display fields including a primary display. In one embodiment a portion of the curved display defines one or both of a touch or gesture based player interface through which the user/player may interact with the controller to control play and aspects of a game.

In one embodiment the video display is disposed to curve from a portion proximate the player to a portion distal from the player and the controller is configured to display at the display a virtual button deck of at least one touch or gesture based input button.

In one embodiment the controller is configured to display at said display a primary and a secondary display.

In one embodiment the curvature of the display is continuous. The display and its curvature is preferably arranged to locate a proximate portion proximate the player and have an upper terminus located further from the player. A touch screen button panel or gesture driven button panel may be disposed at the proximate portion for the player to interface with the game. The center of curvature may be proximate to the player's eyes or above and behind the player's head to provide the desired configuration.

In still a further embodiment, a gaming device for players is provided which includes a cabinet with a base and an upstanding support defining first and second sides for the device. At least one flexible display is disposed on the cabinet to extend from the first side to the second side over the support to define first and second video displays at first and second user/player stations. In a preferred embodiment the displays are curved such as by being OLED displays. The displays may be extensible and the support moveable to increase/decrease the size of the displays. In a preferred arrangement a portion of each display is configured as a touch screen or gesture driven input device to enable the players to interface with the games.

Providing a curved, flexible display such as an OLED display reduces the cost and complexity of providing a large LED or plasma display arranged in a portrait mode and provides for the positioning of a portion of the display to provide a button panel such as a touch screen or gesture driven button panel. Still further the curved display provides for the display of large game displays or multiple displays such as a main game display, a secondary display and a system interface display. In embodiments where the display is expandable, features may be configured for a larger display such as bonus game formats and the like.

### BRIEF DESCRIPTION OF THE DRAWINGS

These and other features and advantages will become appreciated as the same becomes better understood with reference to the description, claims and drawings wherein:

FIG. 1A illustrates a front perspective view of a gaming machine according to the prior art;

FIG. 1B illustrates top-front perspective view of another gaming machine according to the prior art;

FIG. 1B illustrates top-front perspective view of another gaming machine according to the prior art;

FIG. 2 illustrates a perspective view of a gaming device according to an embodiment of the present invention;

FIG. 3A illustrates a perspective view of further embodiment of gaming device of the present invention;

FIG. 3B is a top view of the gaming device of FIG. 3A;

FIG. 4A is a perspective view of the gaming device of FIG. 3A illustrating extension of the video display;

FIG. 4B is a side section view of the gaming device of FIGS. 4A illustrating the extension of the video display;

FIGS. 5A-B illustrates an example of a gaming machine operational platform and components for a gaming device of the type of the present invention; and

FIG. 6 is a logic diagram showing operation of a feature game shown in FIGS. 3A, B and 4A having a touch or gesture based player interface.

### DETAILED DESCRIPTION OF THE PREFERRED EMBODIMENTS

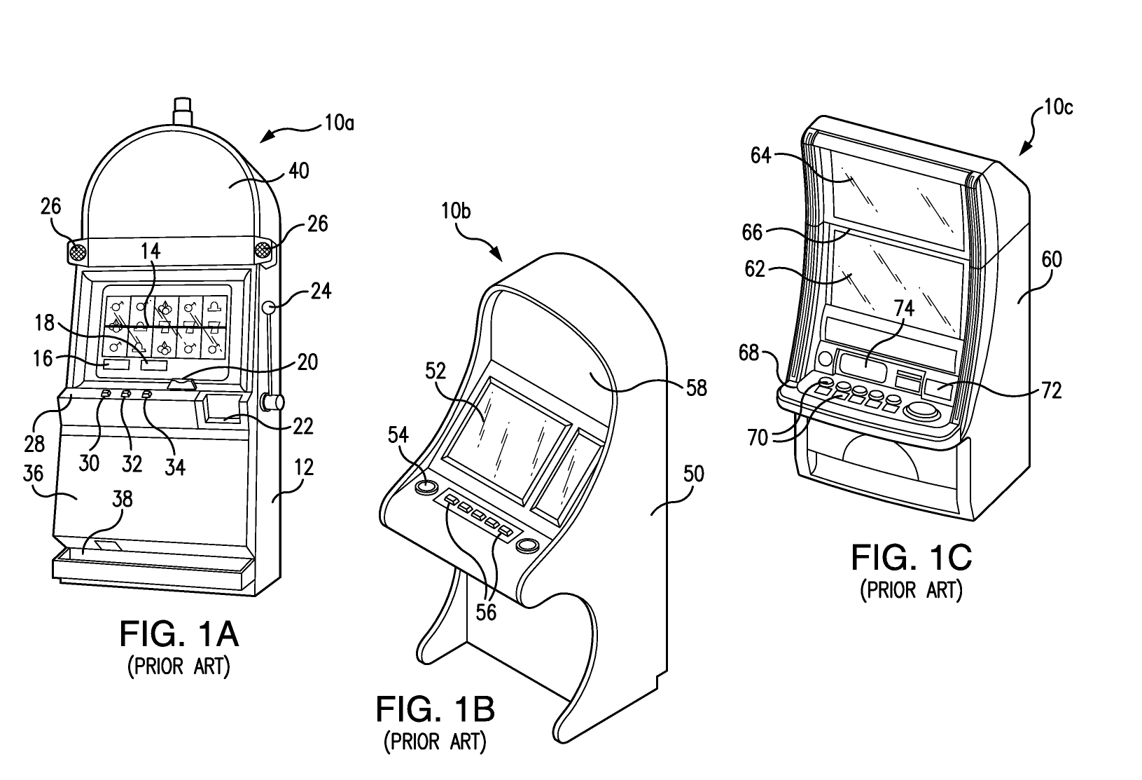

Referring now to the drawings, wherein like reference numbers denote like or corresponding elements throughout the drawings, and more particularly referring to FIG. 1A, a prior art embodiment of a gaming device 10a is shown. The gaming device 10 is an upright gaming device having a cabinet 12 mounting a video display 14 which may be a CRT, LCD or plasma-type of electronic display. The video display 14 is mounted to be substantially vertical. Contained within the cabinet 12 is a game controller (not shown) which controls the video display 14 to display game content shown as a five reel video slot game of the type well known in the art. The video display 14, also as is well known, displays several meters such as a bet meter 16 and a win meter 18 which display the amount of a player's wager and the amount won, respectively, for any play or “spin” of the game. To make a wager the gaming device 10a includes a coin slot 20 to receive and validate coins/tokens and a cash/ticket validator 22 configured to receive and validate cash scrip as well as gaming vouchers. A handle 24 is provided which, when pulled, initiates a play or spin of the game. Speakers 26 are disposed on the cabinet 10a to provide audio signals to augment the video presentation at the video display 14. The gaming device 10a also has a player interface shown as a button deck 28 mounting three buttons such as, for example, a cash out button 30, a bet one credit button 32 and a bet max button 34. As is known in the art the cash out button 30 signals the controller to dispense coins/tokens or print a voucher to cash out the player's accumulated credits. The bet one button 32 enables the player to register a wager of one unit, e.g. $1 and the bet max button 34 enables the player to register the maximum wager permitted by the gaming device.

Continuing with FIG. 1A, the gaming device 10a has a belly glass 36 which is typically plastic printed with the name of the game or other graphics and backlit to identify the game. Below the belly glass 36 is a coin tray 38 to receive coins/tokens dispensed by the gaming device 10.

Above the video display 14 is a top box display 40 which, in the embodiment shown in FIG. 1A is glass or plastic printed with, for example, the pay table for the game as well as game identifying graphics and backlit to display the information to the player.

Turning to FIG. 1B there is shown an example of another prior art gaming device 10b which is of the slant top type. The gaming device 10b has a cabinet 50 mounting a video display 52 which may be a CRT, flat LCD or plasma display and is mounted to be at an angle relate to the vertical. As with the upright gaming device 10a the cabinet 50 houses a game controller which controls the operation of the gaming device 10b including the presentation of content such as a slot machine game, at the video display 52. A player interface is provided such as a button deck 54 mounting a plurality of control buttons 56 of a number and type as is well known in the art and as is consistent with the game provided. Above the video display 52 is a top box 58 which is typically glass or plastic printed with, for example, the pay table for the game as well as game identifying graphics and backlit to display the information to the player.

Turning to FIG. 1C is a more modern version of a prior art gaming device 10c. Gaming device 10c includes a cabinet 60 mounting a main video display 62 shown as a flat screen LCD or plasma display. Above the main video display 62 is a secondary video display 64 which likewise is a flat screen LCD or plasma display. A mounting bezel 66 divides the main display 62 from the secondary display 64. A player interface shown as a button panel 68 mounts a plurality of input buttons 70 through which the player controls the operation of the game. Disposed below the main video display 62 in FIG. 1C is a system interface module 72 which, as is known in the art such as the iView® device manufactured and sold by Bally Gaming, Inc. of Las Vegas, Nev. provides components for the player to interface with a slot management system such as ASCS™ and SDS™ slot management systems also sold by Bally Gaming Inc. of Las Vegas, Nev. The module 72 includes a system interface display 74 to display system provided information to the player such as casino-wide information, information relative to the player's comp point status and the like as well as system provided bonus games and information.

As suggested above the arrangements of the video displays results in certain drawbacks such as expense of providing multiple displays, separate wiring and harnessing, as well as the problem of providing the display of content to the player with large LCD/plasma displays.

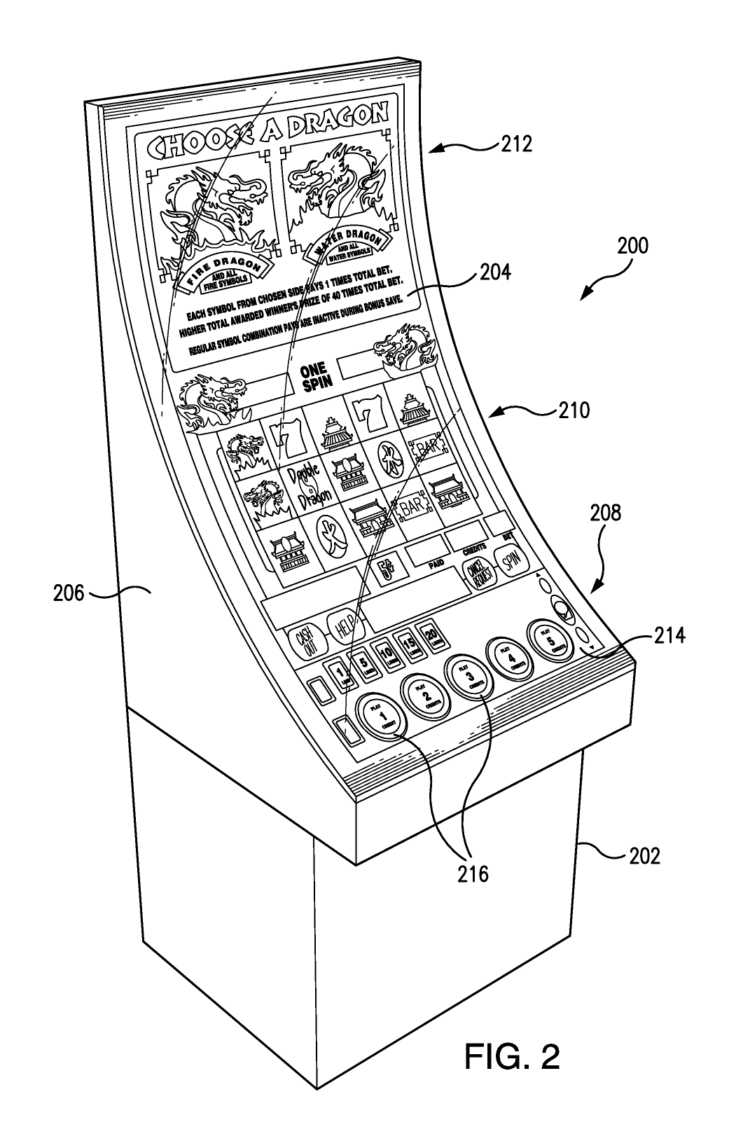

Turning to FIG. 2 there is shown a gaming device 200 according one embodiment of the present invention. It should be understood that the gaming device 200 could also be a terminal or kiosk such as an ATM or airline ticketing kiosk. The gaming device 200 includes a cabinet 202 having mounted thereon a curved display 204. The cabinet 202 includes an upstanding portion 206 such that the cabinet 202 supports the display 204 in the desired position for use by a user/player. Disposed within the cabinet 202 are the electronics necessary to operate the display 200, any interfaces (as hereinafter described) as well as computer processors required to operate the gaming device 200, also as hereinafter described.

The display 204 as shown is curved to present at its lower portion a player interface 208, proximate the middle portion a main game display 210 and at its upper portion a secondary display 212. Preferably the display 204 is a flexible film display such as a color OLED display. The display 204 may be a single flexible OLED display or a plurality of flexible displays configured to present a continuous curvature from the player interface 208 to the secondary display 212 as shown. The cabinet 202 and its upstanding portion 206 are configured to support the curvature of the display 204.

In the preferred embodiment at least the player interface 208 is configured to have a touch screen or gesture based interface. The touch interface may be any touch sensitive input device such as resistive, surface acoustic wave, capacitive (including surface capacitance and projected capacitance), force panel technology or optical imaging as are known in the art. The player interface 208 may also embrace multi-touch technology to receive inputs from simultaneous touching. In lieu of or in addition to a touch input configuration of the player interface 208, the interface may be configure to include gesture based inputs such as by incorporating technology as described in U.S. Pat. Nos. 7,068,204, 7,421,093 and 7,555,142 all titled “Multiple Camera Control System”, U.S. Pat. No. 7,227,526 titled “Video-Based Image Control System” or U.S. Pat. No. 7,379,563 titled “Tracking Bimanual Movements” all issued to Gesture Tek, Inc. the disclosures of which are hereby incorporated by reference.

The controller (not shown in FIG. 2) for the gaming device 200 controls the display 204 to display at the player interface 208 a virtual button deck 214 including plurality of virtual buttons 216 which are coordinated with the input capabilities of the touch and/or gesture driven sensing used to sense player input. By touching or making the requisite gesture at a button the player can interface with the game operated on the gaming device 200 such as making a wager, selecting the pay lines to wager upon, selecting bonus options, cashing out or selecting a denomination (e.g. 1¢, 5¢, 25¢, 50¢or $1) for play.

The touch screen interface and/or gesture input interface may extend to the main game display 210 to enable the player to interact with the game as well such as for picking a bonus option, initiating a bonus, selecting pay lines or the like. The display 200 at the main game display 210 displays, for example, the play of the primary game such as a game matrix 218 of symbols for the video slot machine. Where the gaming device 200 is connected to a slot management system (not shown), the player may need to interface with the system such as to receive a system delivered bonus or message or make an electronic transfer of funds. Where required the game matrix 218 may be re-sized and a system interface display placed at one or both of the player interface 208 or main game display 210 areas. Touch or gesture input devices would receive player input. Alternatively the system interface may be positioned above the main game display 210 within reach by the player. The curved display could be configured by a user (either manually, or automatically based upon some stored preference) to adjust the size of certain display elements such as buttons 216. Another possible use would be to increase the size of the main game display 210 reducing the size of other displayed elements for use, for example, by players with lesser eyesight.

The secondary display 212 may display game graphics, the pay table for the game or other information. Further, during the play of the game the, main game display 208 and secondary display 210 may act as a single display for bonus features, to display advertising or other information, or to display video or graphics as desired by the operator. Inasmuch as there is no physical barrier between the main game display 208 and the secondary display 210 content can extent uninterrupted between to the two display areas. If desired the displayed content may also encompass the player interface 208 such as by showing video or graphics when the gaming device 200 is in an attract mode. For example, when the gaming device 200 is not in use the entire display 204 may be used to display video and graphics such as advertising or video programming.

As shown in FIG. 2, the display 204 for the gaming device 200 is curved defining a continuous arc about a focus point. The focus point may be proximate the position of the eyes of an average sized user/player or above and behind the player such that the player interface 208 and main game display 210 are positioned as desired. The display 204 could likewise be curved but defined by a plurality of foci inasmuch as the display 204 is flexible. The curvature need not be continuous.

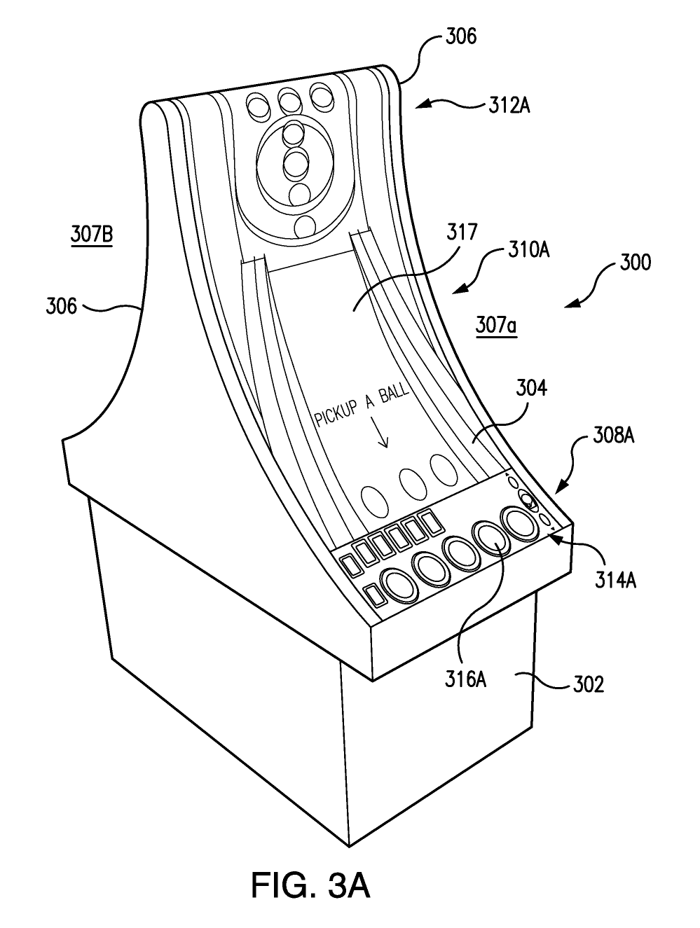

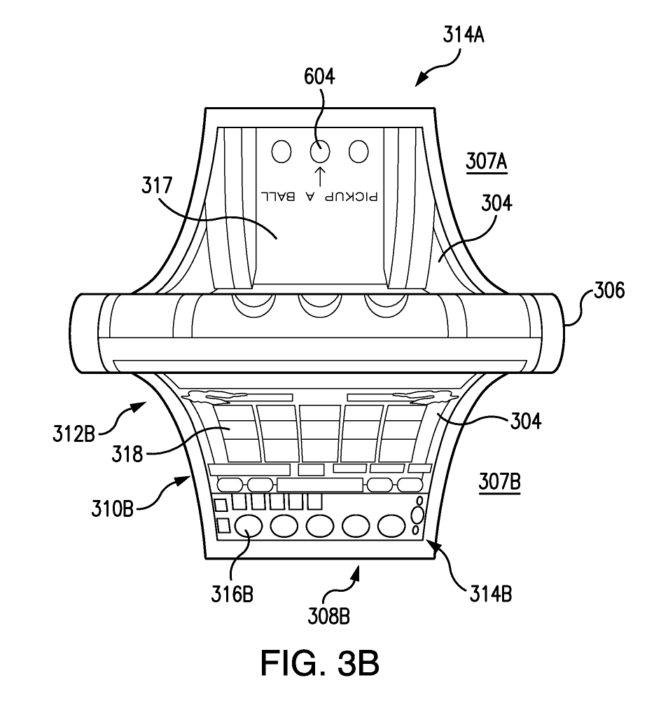

Turning to FIGS. 3A-B there is shown a gaming device 300 according another embodiment of the present invention. It should be understood that the gaming device 300 could also be a terminal or kiosk such as an ATM or airline ticketing kiosk. The gaming device 300 includes a cabinet 302 having mounted thereon a curved display 304. The cabinet 302 includes an upstanding portion 306 such that the cabinet 302 supports the display 304 in the desired position for use by a user/player. Disposed within the cabinet 302 are the electronics necessary to operate the display 300, any interfaces (as hereinafter described) as well as computer processors required to operate the gaming device 300, also as hereinafter described.

The display 304 extends over the cabinet upstanding portion 306 to define user/player stations 307A,B arranged in a back-to-back configuration as shown.

At user/player station 307A the display 304 as shown is curved to present at its lower portion a player interface 308A, proximate the middle portion a main game display 310A and at its upper portion a secondary display 312A. Preferably the display 304, as in the prior embodiment, is a flexible film display such as an OLED color display. The display 304 may be a single flexible OLED display or a plurality of flexible displays configured to present a continuous curvature from the player interface 308A to the secondary display 312A as shown.

In the preferred embodiment at least the player interface 308A is configured to have a touch screen or gesture based interface. The touch interface may be any touch sensitive input device such as resistive, surface acoustic wave, capacitive (including surface capacitance and projected capacitance), force panel technology or optical imaging as are known in the art. The player interface 308A may also embrace multi-touch technology to receive inputs from simultaneous touching. In lieu of or in addition to a touch input configuration of the player interface 308A, the interface may be configure to include gesture based inputs as described above.

The controller (not shown in FIG. 2) for the gaming device 300 controls the display 304 to display at the player interface 308A a virtual button deck 314A including plurality of virtual buttons 316A which are coordinated with the input capabilities of the touch and/or gesture driven sensing used to sense player input. By touching or making the requisite gesture at a button the player can interface with the game operated at player station 307A such as making a wager, selecting the pay lines to wager upon, selecting bonus options, cashing out or selecting a denomination (e.g. 1¢, 5¢, 25¢, 50¢ or $1) for play.

The touch screen interface and/or gesture input interface may extend to the main game display 310A to enable the player to interact with the game such as for picking a bonus option, initiating a bonus, selecting pay lines or the like.

The display 300 at the main game display 310A displays, for example, the play of the primary game such as a game matrix 318 of symbols for the video slot machine or a bonus game display 317 such as Skee-Ball® (“Skee-Ball” is a United States Registered Trademark of Skee-Ball, Inc.). Where the gaming device 300 is connected to a slot management system (not shown), the user/player may need to interface with the system such as to receive a system delivered bonus or message or make an electronic transfer of funds. Where required the game matrix 318 may be re-sized and a system interface display placed at one or both of the player interface 308A,B or main game display 310A,B areas. Touch or gesture input devices would receive player input. Alternatively the system interface may be positioned above the main game display 310A,B within reach by the player.

The secondary display 312A may display game graphics, the pay table for the game or other information. Further, during the play of the game the, main game display 308A,B and secondary display 310A,B may act as a single display for bonus features, to display advertising or other information, or to display video or graphics as desired by the operator. For example, in FIGS. 3A,B at the player station 307A a bonus game of Skee-Ball is shown encompassing both the main game and secondary displays 310A, 312A. For this bonus the main game display 310A may include touch or gesture input devices to permit the player to toss the virtual Skee-Ball toward the target. Inasmuch as there is no physical barrier between the main game displays 308A,B and the secondary displays 210A,B content can extend uninterrupted between the two display areas. If desired the displayed content may also encompass the player interfaces 308A,B such as by showing video or graphics when the gaming device 300 is in an attract mode. For example, when the gaming device 300 is not in use the entire display 304 may be used to display video and graphics such as advertising or video programming.

As shown the display 304 for the gaming device 300 is curved for each player station 307A,B defining a continuous arc about a focus point. The display 304 could likewise be curved but discontinuous as defined by a plurality of foci inasmuch as the display 304 is flexible.

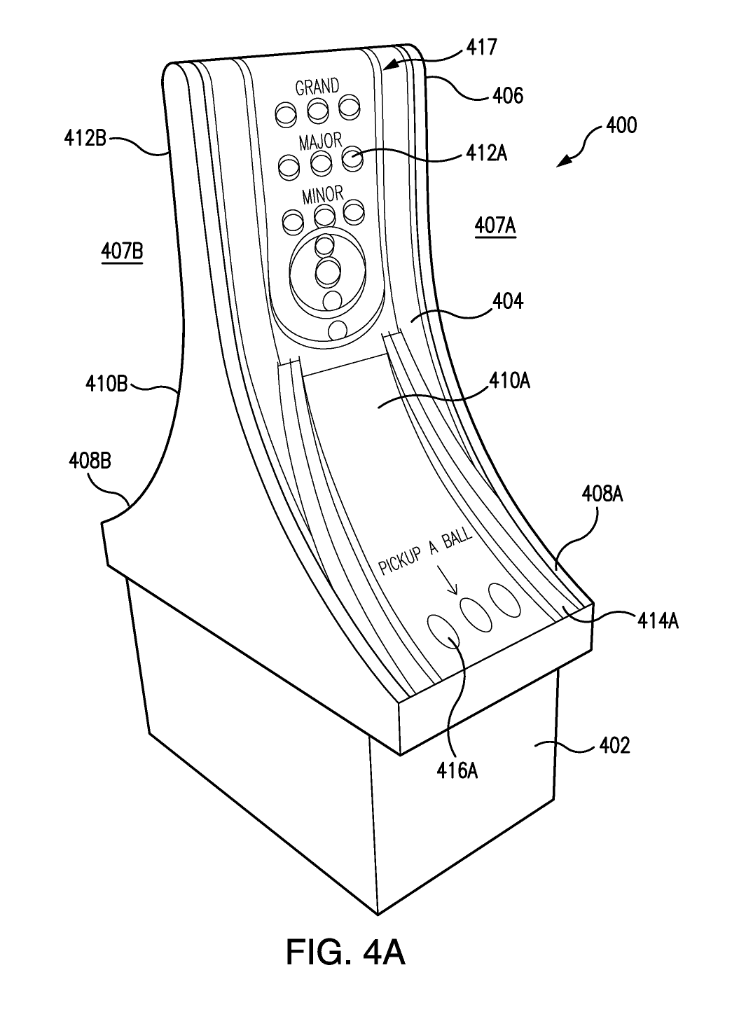

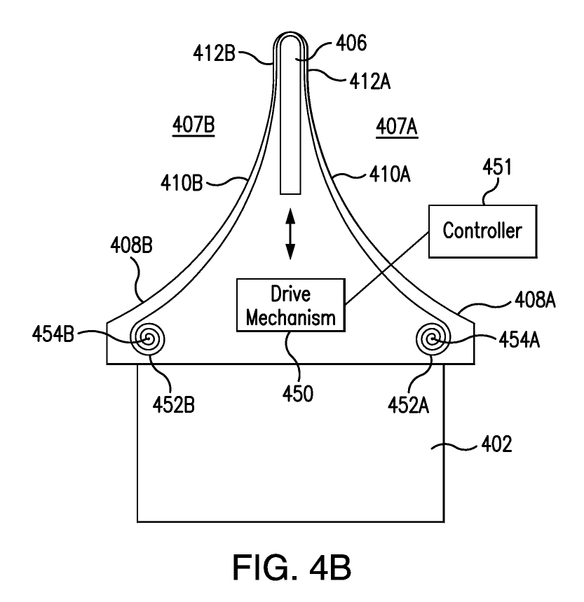

Turning to FIGS. 4A,B yet a further embodiment of the present invention is shown. While this embodiment is shown as a variation of the embodiment of FIGS. 3A,B the teachings could be applied to the embodiment of FIG. 2 as well.

According to this embodiment the gaming device 400 includes a cabinet 402 as well as the flexible, curved display 404 generally of the type described with reference to the display 302. The cabinet 402 has an extensible upstanding portion 406 which is vertically moveable between a lowered and a raised position. Disposed within the cabinet 402 are the electronics necessary to operate the display 404, the extensible portion 406, any interfaces (as hereinafter described) as well as computer processors required to operate the gaming device 300, also as hereinafter described.

The display 404 extends over the cabinet upstanding portion 406 to define user/player stations 407A,B arranged in a back-to-back configuration as shown.

At user/player station 407A the display 404 as shown is curved to present at its lower portion a player interface 408A, proximate the middle portion a main game display 410A and at its upper portion a secondary display 412A. Preferably the display 404, as in the prior embodiment, is a flexible film display such as an OLED color display. The display 404 may be a single flexible OLED display or a plurality of flexible displays configured to present a continuous curvature from the player interface 408A to the secondary display 412A as shown.

In the preferred embodiment at least the player interface 408A is configured to have a touch screen or gesture based interface. The touch interface may be any touch sensitive input device such as resistive, surface acoustic wave, capacitive (including surface capacitance and projected capacitance), force panel technology or optical imaging as are known in the art. The player interface 408A may also embrace multi-touch technology to receive inputs from simultaneous touching. In lieu of or in addition to a touch input configuration of the player interface 408A, the interface may be configure to include gesture based inputs as described above.

The controller (not shown in FIG. 2) for the gaming device 400 controls the display 404 to display at the player interface 408A a virtual button deck 414A including plurality of virtual buttons 416A which are coordinated with the input capabilities of the touch and/or gesture driven sensing used to sense player input. By touching or making the requisite gesture at a button the player can interface with the game operated at player station 407A such as making a wager, selecting the pay lines to wager upon, selecting bonus options, cashing out or selecting a denomination (e.g. 1¢, 5¢, 25¢, 50¢or $1) for play.

The touch screen interface and/or gesture input interface may extend to the main game display 410A to enable the player to interact with the game as well such as for picking a bonus option, initiating a bonus, selecting pay lines or the like.

The display 400 at the main game display 410A displays, for example, the play of the primary game such as a game matrix of symbols for the video slot machine or a bonus game display 417 such as Skee-Ball. Where the gaming device 400 is connected to a slot management system (not shown), the user/player may need to interface with the system such as to receive a system delivered bonus or message or make an electronic transfer of funds. Where required the game matrix may be re-sized and a system interface display placed at one or both of the player interface 408A,B or main game display 410A,B areas. Touch or gesture input devices would receive player input. Alternatively the system interface may be positioned above the main game display 410A,B within reach by the player.

The secondary display 412A may display game graphics, the pay table for the game or other information. Further, during the play of the game the, main game display 408A,B and secondary display 410A,B may act as a single display for bonus features, to display advertising or other information, or to display video or graphics as desired by the operator. For example, in FIG. 4A at the player station 407A a bonus game of Skee-Ball is shown encompassing both the main game and secondary displays 310A, 312A. For this bonus the main game display 410A may include touch or gesture input devices to permit the player to toss the virtual Skee-Ball toward the target. Inasmuch as there is no physical barrier between the main game displays 408A,B and the secondary displays 410A,B content can extend uninterrupted between the two display areas. If desired the displayed content may also encompass the player interfaces 408A,B such as by showing video or graphics when the gaming device 400 is in an attract mode. For example, when the gaming device 300 is not in use the entire display 304 may be used to display video and graphics such as advertising or video programming.

The extensible portion 406 includes a drive mechanism 450 of the type to raise and lower the portion as suggested in FIG. 4B. The mechanism may be, for example a rack and meshing motor driven gear, a winch-type wining mechanism or the like. The drive mechanism 450 is controlled by the game controller 451 to, when required by game play and graphics, raise and lower the extensible portion 406.

To accommodate the raising the lowering of the extensible portion the display 404 includes at both player stations 407A,B display inventory 452A,B which may be rolled on a biased roll 454A,B or otherwise retained in a concealed fashion to unfurl and furl as the extensible portion 406 is raised and lowered to increase the displayed area of the display 404. For example, when a bonus game is triggered additional display area may be desired to show the features of the bonus. The game controller 451 controls the drive mechanism 450 to raise the upstanding portion 406 which in turn unrolls additional display from the rolls 454A,B. When the bonus is concluded the upstanding portion 406 is lowered and the biased rolls 454A,B take up the excess display 304 material. In this fashion the display 404 can be increased and decreased in size as desired. The flexible display 404 accommodates the increase and decrease by providing for the extension take up of the additional display areas.

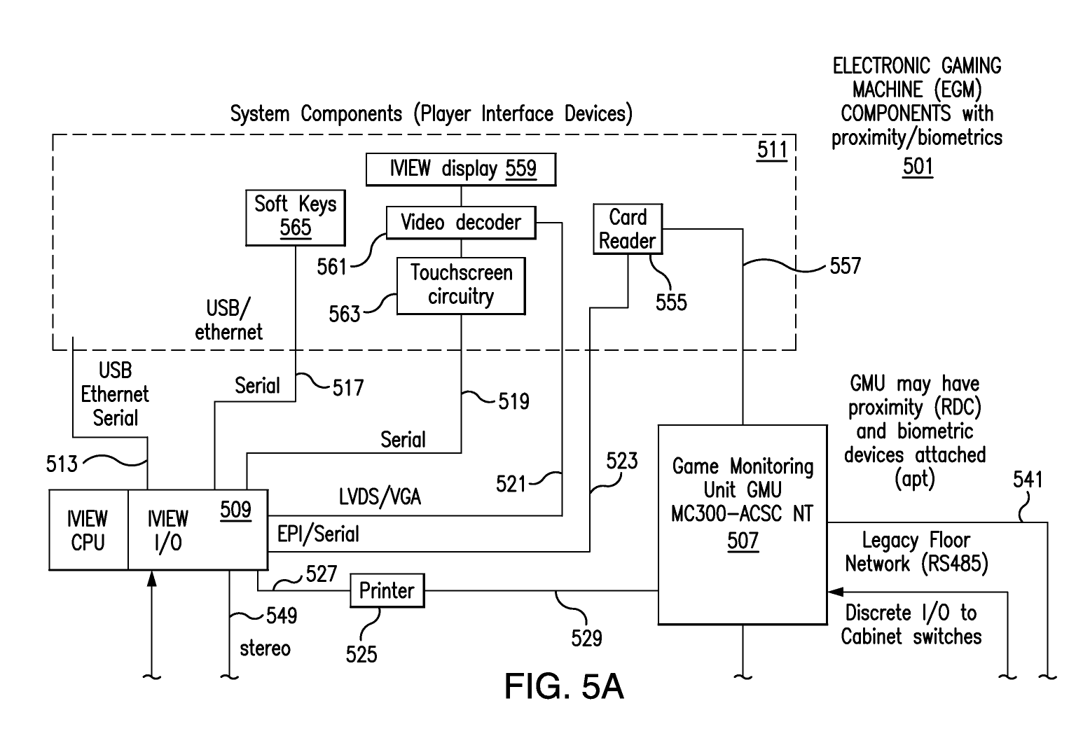

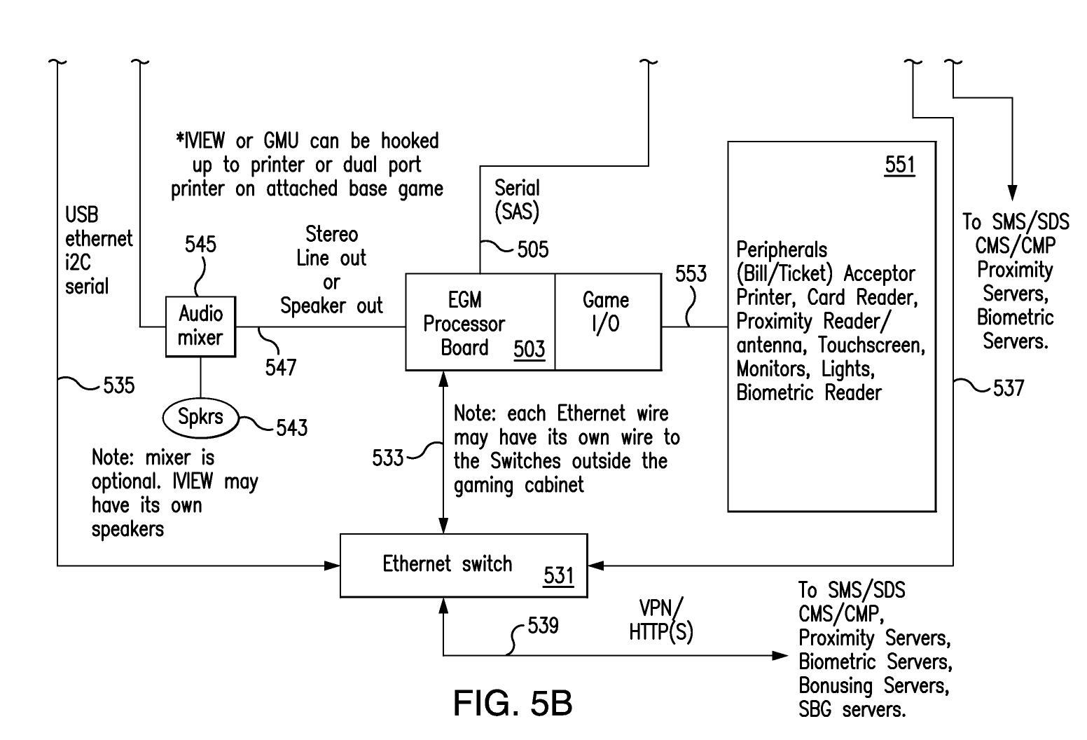

Referring to FIGS. 5A,B, the gaming devices 200,300,400 hardware 501 for their controller(s) is shown in accordance with one or more embodiments. It should be understood that one or more controllers could be included particularly for the embodiment shown in FIGS. 4A,B where a single display 404 is provided for multiple player stations 407A,B. The hardware 501 includes base game integrated circuit board 503 (EGM Processor Board) connected through serial bus line 505 to game monitoring unit (GMU) 507 (such as a Bally MC300 or ACSC NT), and player interface integrated circuit board (PIB) 509 connected to player system interface devices 511 over bus lines 513, 517, 519, 521, 523. Gaming voucher ticket printer 525 (for printing player cashout tickets) is connected to PIB 509 and GMU 507 over bus lines 527, 529. EGM Processor Board 503, PIB 509, and GMU 507 connect to Ethernet switch 531 over bus lines 533, 535, 537. Ethernet switch 531 connects to a slot management system (SMS) and a casino management system (CMS) network over bus line 539. Ethernet switch 531 may also connect to a server based gaming server or a downloadable gaming server. GMU 507 also may connect to the SMS and CMS network over bus line 541. Speakers 543 to produce sounds related to the game or according to the present invention connect through audio mixer 545 and bus lines 547, 549 to EGM Processor Board 503 and PIB 509.

Peripherals 551 connect through bus 553 to EGM Processor Board 503. The peripherals 551 include, but are not limited to the following and may include individual processing capability: bill/ticket acceptor to validate and accept currency and ticket vouchers, player loyalty card reader, the player interfaces 208, 308A, 408A including features to support the touch screen/gesture functionality, display 204, 304, 404 with touch screen/gesture recognition functionality , monitors and lights. For example, a bill/ticket acceptor is typically connected to the game input-output board of the EGM processing board 503 (which is, in turn, connected to a conventional central processing unit (“CPU”) board), such as an Intel Pentium microprocessor mounted on a gaming motherboard. The I/O board may be connected to CPU processor board by a serial connection such as RS-232 or USB or may be attached to the processor by a bus such as, but not limited to, an ISA bus. The gaming motherboard may be mounted with other conventional components, such as are found on conventional personal computer motherboards, and loaded with a game program which may include a gaming machine operating system (OS), such as a Bally Alpha OS. EGM processor board 503 executes a game program that causes the gaming device 200, 300, 400 to display and play a game. The various components and included devices may be installed with conventionally and/or commercially available components, devices, and circuitry into a conventional and/or commercially available gaming machine cabinet, examples of which are described above.

When a player has inserted a form of currency such as, for example and without limitation, paper currency, coins or tokens, cashless tickets or vouchers, electronic funds transfers or the like into the currency acceptor, a signal is sent by way of bus 553 to the I/O board and to EGM processor board 503 which, in turn, assigns an appropriate number of credits for play in accordance with the game program. The player may further control the operation of the gaming machine by way of other peripherals 551, for example, to select the amount to wager via the player interface 208, 308A, 408A. The game starts in response to the player operating a start mechanism such as a handle, button such as a SPIN/RESET button 216 touch screen icon. The game program includes a random number generator to provide a display of randomly selected indicia on one or more displays such as the main display game matrix 218 as shown in FIG. 2. In some embodiments, the random generator may be physically separate from gaming device 200, 300, 400; for example, it may be part of a central determination host system which provides random game outcomes to the game program. Finally, processor board 503 under control of the game program and OS compares the final display of indicia to a pay table. The set of possible game outcomes may include a subset of outcomes related to the triggering of a feature or bonus game such as the Skee-Ball® game shown in FIGS. 3A, B, and FIG. 4A. In the event the displayed outcome is a member of this subset, processor board 503, under control of the game program and by way of I/O Board 553, may cause feature game play to be presented on the display 204, 304, 404.

Predetermined payout amounts for certain outcomes, including feature game outcomes, are stored as part of the game program. Such payout amounts are, in response to instructions from processor board 503, provided to the player in the form of coins, credits or currency via I/O board and a pay mechanism, which may be one or more of a credit meter, a coin hopper, a voucher printer, an electronic funds transfer protocol or any other payout means known or developed in the art.

In various embodiments, the game program is stored in a memory device (not shown) connected to or mounted on the gaming motherboard. By way of example, but not by limitation, such memory devices include external memory devices, hard drives, CD-ROMs, DVDs, and flash memory cards. In an alternative embodiment, the game programs are stored in a remote storage device. In one embodiment, the remote storage device is housed in a remote server such as a downloadable gaming server. The gaming machine may access the remote storage device via a network connection, including but not limited to, a local area network connection, a TCP/IP connection, a wireless connection, or any other means for operatively networking components together. Optionally, other data including graphics, sound files and other media data for use with the EGM are stored in the same or a separate memory device (not shown). Some or all of the game program and its associated data may be loaded from one memory device into another, for example, from flash memory to random access memory (RAM).

In one or more embodiments, peripherals may be connected to the system over Ethernet connections directly to the appropriate server or tied to the system controller inside the EGM using USB, serial or Ethernet connections. Each of the respective devices may have upgrades to their firmware utilizing these connections.

GMU 507 includes an integrated circuit board and GMU processor and memory including coding for network communications, such as the G2S (game-to-system) protocol from the Gaming Standards Association, Las Vegas, Nev., used for system communications over the network. As shown, GMU 507 may connect to a player card reader 555 through bus 557 and may thereby obtain player card information and transmit the information over the network through bus 541. Gaming activity information may be transferred by the EGM Processor Board 503 to GMU 507 where the information may be translated into a network protocol, such as S2S, for transmission to a server, such as a player tracking server, where information about a player's playing activity may be stored in a designated server database.

PID 509 includes an integrated circuit board, PID processor, and memory which includes an operating system, such as Windows CE, a player interface program which may be executable by the PID processor together with various input/output (I/O) drivers for respective devices which connect to PID 509, such as player interface devices 511, and which may further include various games or game components playable on PID 509 or playable on a connected network server and PID 509 is operable as the player interface. PID 509 connects to card reader 555 through bus 523, player tracking display 559 through video decoder 561 and bus 521, such as an LVDS or VGA bus.

As part of its programming, the PID processor executes coding to drive player tracking display 559 and provide messages and information to a player. Touch screen circuitry 563 interactively connects display 559 and video decoder 561 to PID 509, such that a player may input information and cause the information to be transmitted to PID 509 either on the player's initiative or responsive to a query by PID 509. Additionally soft keys 565 connect through bus 517 to PID 509 and operate together with the player tracking display 559 to provide information or queries to a player and receive responses or queries from the player. PID 509, in turn, communicates over the CMS/SMS network through Ethernet switch 531 and busses 535, 539 and with respective servers, such as a player tracking server.

Player interface devices 511 are linked into the virtual private network of the system components in gaming machine 501. The system components include the iVIEW® device (“iView” is a registered trademark of Bally Gaming, Inc.) processing board and game monitoring unit (GMU) processing board. These system components may connect over a network to the slot management system (such as a commercially available Bally SDS/SMS) and/or casino management system (such as a commercially available Bally CMP/CMS).

The GMU system component has a connection to the base game through a serial SAS connection and is connected to various servers using, for example, HTTPs over Ethernet. Through this connection, firmware, media, operating system software, gaming machine configurations can be downloaded to the system components from the servers. This data is authenticated prior to install on the system components.

The system components include the iVIEW device processing board and game monitoring unit (GMU) processing board. The GMU and iVIEW device can be combined into one like the commercially available Bally GTM iVIEW device. This device may have a video mixing technology to mix the EGM processor's video signals with the iVIEW display onto the top box monitor or any monitor on the gaming device.

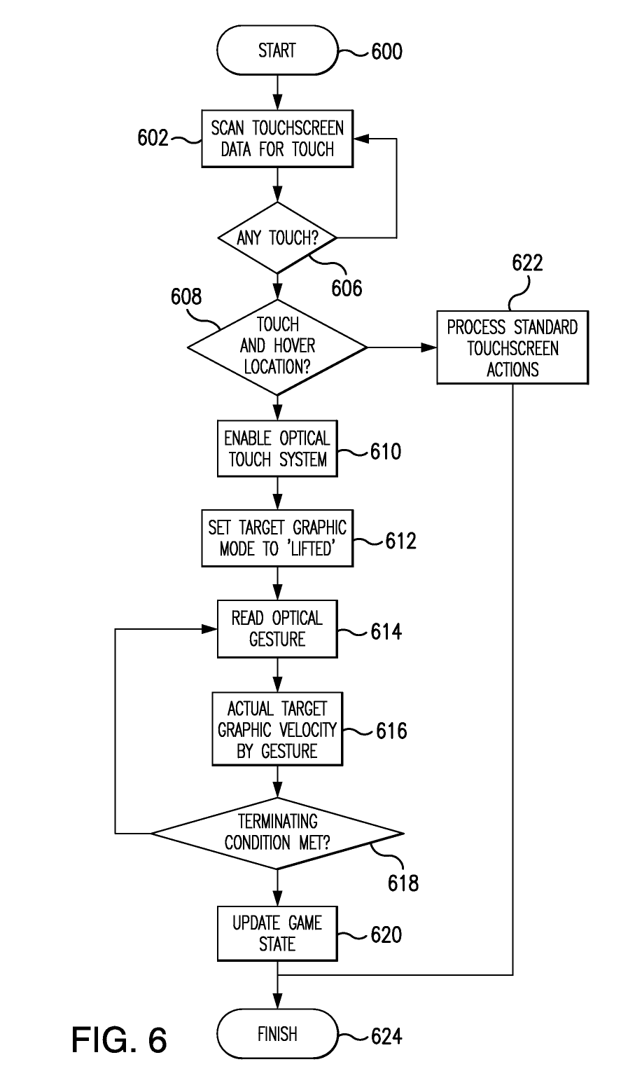

Turning now to FIG. 6 a logic diagram is shown related to the play of a bonus game such as Skee-Ball as shown in the drawings. At 600 to bonus feature is initiated triggered, for example, by one or more symbols being selected and displayed at the game matrix 218 or randomly triggered by other techniques. When triggered the hardware 501 EGM processor board 503 controls the display 304 to display the graphics supporting the bonus feature game. According to the play of the feature the player is urged to control the launching of one or more balls along an alley toward a target. As shown in FIGS. 3A, B the alley is displayed in the area of the main game display 310A and the target is shown displayed at the area of the secondary display 312A. Inasmuch as the display 304 is continuous (i.e. there are no physical or graphic barriers crossing the display 304A, the features of the Skee-Ball game can be shown as a composite over much/all of the display 304 mimicking a physical Skee-Ball game one might find at a carnival. At 602 the touch interface (peripheral 551 of FIG. 5A and/or EGM processor board 503) scans the player interface 308A for any touch particularly the player touching an icon of a ball 604 displayed at the display 304. If at 606 a touch is detected at 608 the location is determined and at 610 an optical touch system is enabled. The optical touch system or gesture recognition system is then configured at 612 to display the target graphic (icon of the selected ball 604) as being lifted from the alley. The player then makes a gesture as if rolling the ball 604 along the alley toward the target which at 614 is read by the touch or gesture recognition system. The motion may be above the display 304 where the gesture if being read or where the display 304 has a touch screen the player may slide their finger upward along the alley to simulate rolling of the ball 604. At 616 the EGM processor board 503 (or other local or connected controller) adjusts the velocity and direction of the rolling ball 604 during the touch/gesture until at 618 a terminating condition is met meaning the player has completed their gesture/touch. At 620 the game state is updated by showing the ball 604 rolling to and entering the target to reveal a bonus. In one embodiment the bonus may be randomly selected at the “toss” with the graphics showing the ball 604 following a trajectory to trigger the selected bonus. In another embodiment the actions of the player may influence the bonus awarded adding a degree of skill to the game. In yet another embodiment the result may be a combination of skill and chance for example based upon the player's toss they will win a prize from a randomly selected group of prizes.

If at 608 a touch and hover interface is not sensed, at 622 the controller processes the standard touch screen action such as button selections and the like. At 624 the process is finished.

Other bonus games and features can be provided by the device of the present invention including arcade games and the like.

Preferably the curved display 204, 304, 404 is a color, flexible OLED or LED display. The flexibility permits the display to be positioned in the curved fashion as shown so at to present the game/content displays in positions for view by the user but also to position the player interface of the display in a position and orientation for use by the player.

While the example embodiments have been described with relation to a gaming environment, it will be appreciated that the above concepts can also be used for kiosks and other user terminals.

The foregoing description, for purposes of explanation, uses specific nomenclature and formula to provide a thorough understanding of the invention. It should be apparent to those of skill in the art that the specific details are not required in order to practice the invention. The embodiments have been chosen and described to best explain the principles of the invention and its practical application, thereby enabling others of skill in the art to utilize the invention, and various embodiments with various modifications as are suited to the particular use contemplated. Thus, the foregoing disclosure is not intended to be exhaustive or to limit the invention to the precise forms disclosed, and those of skill in the art recognize that many modifications and variations are possible in view of the above teachings.

What is claimed is:

1. A video terminal for a user comprising:
a cabinet having a base and a video support upstanding from said base;
a curved video display secured to said support;
an input interface;
a controller configured to display at said display a plurality of display fields including a primary display.

2. The gaming device of claim 1 comprising at least a portion of said display defining a touch screen or gesture input device.

3. The gaming device of claim 1 comprising at least a portion of said display defining a button panel input interface.

4. The gaming device of claim 1 comprising at least a portion of said display defining a touch screen button panel input interface.

5. The gaming device of claim of claim 1 comprising at least a portion of said display defining a gesture-based input interface.

6. The gaming device of claim 1 comprising said video display is disposed to curve from a portion proximate the player to a portion remote from the player and said controller is configured to display at said display a virtual button deck of at least one touch screen interface at said proximate portion.

7. The gaming device of claim 1 comprising said video display is configured to display a secondary game display.

8. The gaming device of claim 1 comprising said video display is configured to display a player system interface display.

9. The gaming machine of claim 1 comprising the curvature of said video display is continuous.

11. The gaming device of claim 1 said video display has a radius of curvature centered above the player to define a portion proximate the player to a portion remote from the player.

12. The device of claim 1 wherein said video display is a flexible video display and further comprising a curved substrate to support said display.

13. The device of claim 12 comprising said display is an OLED display.

14. A gaming device for play by a player comprising:
a cabinet;
a flexible, curved display mounted to said cabinet to continuously curve from a proximate portion located proximate the player to a remote terminus;
a touch screen interface displayed at said proximate portion;
a controller configured to control the display to display at least one input button in cooperation with said touch screen interface for the player to select an input and to display game content at a main game display.

15. The gaming device of claim 14 comprising said controller is configured to display a secondary display.

16. The gaming device of claim 15 comprising a controller to display at said display a system interface display.

17. The gaming device of claim 14 comprising said display is a flexible video display.

18. The gaming device of claim 17 comprising said video display is an OLED display.

19. A gaming device for players and operated by a controller comprising:
a cabinet having a base, a first side, a second side and an upstanding support;
at least one flexible video display disposed on said cabinet to extend from said first side to said second side and over said support to define a first and second curved displays at said first and second sides;
a player interface device for each of said first and second sides. and
at least one controller configured to display at each of said first and second displays a main game display.

21. The gaming device of claim 19 comprising said video display at least at one of said sides is curved.

22. The gaming device of claim 21 comprising said video display at both sides is curved.

23. The device of claim 19 comprising said video display is extensible and said support is moveable to increase the size of said first and second video displays.

24. The device of claim 19 comprising at least a portion of said display defining a touch screen or gesture input device.

25. The gaming device of claim 19 comprising at least a portion of said display defining a button panel input interface.

26. The gaming device of claim 19 comprising at least a portion of said display defining a touch screen button panel input interface.

27. The gaming device of claim of claim 19 comprising at least a portion of said display defining a gesture-based input interface.

28. The gaming device of claim 19 comprising said video display at least as one of said sides is disposed to curve from a portion proximate the player to a portion remote from the player and said controller is configured to display at said display a virtual button deck of at least one touch screen interface at said proximate portion.
